(19) United States
(12) Patent Application Publication
(10) Pub. No.: US 2020/0103887 A1
(43) Pub. Date: Apr. 2, 2020

(54) METHOD OF FAULT PREDICTION OF A CYCLICALLY MOVING MACHINE COMPONENT

(71) Applicant: Tetra Laval Holdings & Finance S.A., Pully (CH)

(72) Inventors: Marco Cocconcelli, Reggio Emilia (IT); Luca Capelli, Novellara (Reggio Emilia) (IT); Davide Borghi, Modena (IT)

(21) Appl. No.: 16/621,038

(22) PCT Filed: Apr. 26, 2018
(86) PCT No.: PCT/EP2018/060773

§ 371 Date: Dec. 10, 2019

(30) Foreign Application Priority Data
Jun. 12, 2017 (EP) 17175556.4

(51) Int. Cl. G05B 23/02; G01H 1/00; G01M 13/045

(52) U.S. Cl. CPC G05B 23/0283; G01M 13/045; G05B 23/0232; G01H 1/003

(57) ABSTRACT

A method of fault prediction of a cyclically moving machine component is disclosed, wherein each cycle of a plurality of cycles of a motion of the component generates a data distribution of values of measurable movement characteristics during a duration of each cycle. The method comprises, for each cycle; determining said data distribution of the movement characteristics; calculating a measure of central tendency of the values in the data distribution; calculating a quantified measure of a shape of the data distribution over the duration of each cycle; associating the measure of central tendency with said quantified measure of the shape as a coupled set of condition parameters; determining a degree of dispersion of a plurality of coupled sets of condition parameters associated with a plurality of cycles of the cyclically moving component; and comparing the degree of dispersion with a dispersion threshold value, or determining a trend of the degree of dispersion over time, for said fault prediction.

### TECHNICAL FIELD

The present invention generally relates to the field of condition monitoring. More particularly, the present invention relates to a method of fault prediction of a cyclically moving machine component, a related computer program product and an apparatus for predicting fault in a cyclically moving machine component such as bearings, belts, or motors, employed in systems such as filling machines or related systems for producing sealed packages.

### BACKGROUND

Condition monitoring of machine components such as bearings, belts, motors, or any other of the component in production lines, such as in the manufacturing of sealed packages in a filling machine or related systems, is critical for ensuring a desired functionality over a period of time and fault prediction. Monitoring distortions in the movements of such components, such as vibrations in cyclically moving components in those systems, is one essential part in achieving the desired functionality control and prevent wear-related breakdown. Such maintenance strategy is mainly possible thanks to the fact that once e.g. a bearing approaches failure, it becomes noisy and vibrates as a warning sign of the impending breakdown, and if this sign is detected timely it gives the operator a time frame to plan a maintenance activity and substitute the bearing without impacting production time. Distortion analysis of e.g. vibrations is an important part of industrial predictive maintenance programs so that wear and damages in the bearings can be discovered and repaired before the machine breaks down, thus reducing operating and maintenance costs. Empirical evaluation of the vibration level of a bearing is an error-prone activity that may lead to significantly underestimate or overestimate the remaining lifetime of the component, and also to mistake for a bearing damage a noise that is due to a completely different cause (e.g. a shaft imbalance). Previous solutions that aim to characterize bearing faults include frequency analysis, where characteristic frequency signatures are extracted from the vibration signal. Besides from being complex to implement, solutions based on frequency analysis are not always accurate and makes various assumptions with regards to the model used for the calculations. In particular, it is typically assumed that there is no slip during the relative motion of the bearing elements; that there is a localized damage on the bearing; that the motor to which the bearing is attached to rotates at a constant speed; and during the motor operation, the damage causes a series of short-duration impacts, that generate a train of spikes in the frequency spectrum of the vibration signal with a certain periodicity; and that there is a frequency band where the signal-to-noise ratio is such that the train of impulses is detectable. If these conditions are not verified, the train of peaks may be smeared so that it is not recognizable anymore, or can be hidden among other kinds of noise. The assumption of constant rotation speed of the servomotors is severe limitation in the field of automatic machines, where usually a number of servomotors are employed as electric cams and operated at a variable speed in order to obtain variable speed profiles of the actuated elements. Methods are employed to accommodate for variable speeds, but such solutions can also be complex to implement and also associated with other limitations and undesirable assumptions.

Hence, an improved condition monitoring would be advantageous and in particular allowing for avoiding more of the above-mentioned problems and compromises, including providing a less complex method of fault prediction, having short execution time and thereby enabling analysis on-the-fly, thereby allowing for a less time-consuming and robust trouble-shooting of a cyclically moving machine component.

### SUMMARY

Accordingly, examples of the present invention preferably seek to mitigate, alleviate or eliminate one or more deficiencies, disadvantages or issues in the art, such as the above-identified, singly or in any combination by providing a device according to the appended patent claims.

According to a first aspect a method of fault prediction of a cyclically moving machine component is provided, wherein each cycle of a plurality of cycles of a motion of the component generates a data distribution of values of measurable movement characteristics during a duration of each cycle. The method comprises, for each cycle; determining said data distribution of the movement characteristics; calculating a measure of central tendency of the values in the data distribution; calculating a quantified measure of a shape of the data distribution over the duration of each cycle; associating the measure of central tendency with said quantified measure of the shape as a coupled set of condition parameters; determining a degree of dispersion of a plurality of coupled sets of condition parameters associated with a plurality of cycles of the cyclically moving component; and comparing the degree of dispersion with a dispersion threshold value, or determining a trend of the degree of dispersion over time, for said fault prediction.

According to a second aspect a computer program product comprising instructions which, when the program is executed by a computer, cause the computer to carry out the steps of the method according to the first aspect.

According to a third aspect an apparatus configured to predict fault in a cyclically moving component is disclosed, wherein each cycle of a plurality of cycles of a motion of the component generates a data distribution of values of measurable movement characteristics during a duration of each cycle. The apparatus comprises a processing unit configured to, for each cycle; determine said data distribution of the movement characteristics; calculate a measure of central tendency of the values in the data distribution; calculate a quantified measure of a shape of the data distribution over the duration of each cycle; associate the measure of central tendency with said quantified measure as a coupled set of condition parameters; determine a degree of dispersion of a plurality of coupled sets of condition parameters associated with a plurality of cycles of the cyclically moving component; and compare the degree of dispersion with a dispersion threshold value, or determine a trend of the degree of dispersion over time, for said fault prediction.

Further examples of the invention are defined in the dependent claims, wherein features for the second and third aspects of the disclosure are as for the first aspect mutatis mutandis.

Some examples of the disclosure provide for an improved method for predicting fault in a machine component.

Some examples of the disclosure provide for facilitated prediction of the life-time of a machine component.

Some examples of the disclosure provide for a more predictable and efficient maintenance schedule of a machine component.

Some examples of the disclosure provide for a method of fault prediction, having short execution time and thereby enabling analysis on-the-fly.

Some examples of the disclosure provide for avoiding faulty cyclically moving machine components such as bearings, belts, motors.

Some examples of the disclosure provide for a more efficient method of evaluating the quality of cyclically moving machine components.

Some examples of the disclosure provide for less time-consuming trouble-shooting of cyclically moving machine components.

Some examples of the disclosure provide for improved characterization of measurable movement characteristics of a cyclically moving machine component such as vibration characteristics.

Some examples of the disclosure provide for improved condition monitoring in a machine such in a filling machine, having cyclically moving machine components.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

These and other aspects, features and advantages of which examples of the invention are capable of will be apparent and elucidated from the following description of examples of the present invention, reference being made to the accompanying drawings, in which;

FIG. 1 is a diagram illustrating a data distribution of movement characteristics of a cyclically moving machine component, where the amplitude of a vibration signal is being plotted over the duration of one cycle;

FIG. 2a is a diagram of coupled sets of condition parameters, where each set, i.e. data point, is determined as a measure of a central tendency of the values of the data distribution in FIG. 1 versus a quantified measure of a shape of the data distribution, according to one example of the disclosure, for two different times;

FIG. 2b is a magnified view of the coupled sets of condition parameters in FIG. 2a at time t₂;

FIGS. 3a-b are diagrams of a radius of a circle circumflexing the data points of the sets of condition parameters in FIGS. 2a-b versus the percentage of data points being contained within the aforementioned circle, for two different machine components;

FIGS. 4a-b are diagrams of a radius of a circle circumflexing the data points of the sets of condition parameters in FIGS. 2a-b versus the percentage of data points being contained within the aforementioned circle, for two different machine components;

FIG. 5 is a flowchart of a method of fault prediction of a cyclically moving machine component according to one example of the disclosure;

FIG. 6 is a flowchart of a method of fault prediction of a cyclically moving machine component according to one example of the disclosure; and

FIG. 7 is a schematic illustration of an apparatus configured to predict fault in a cyclically moving component according to one example of the disclosure.

### DETAILED DESCRIPTION

Specific examples of the invention will now be described with reference to the accompanying drawings. This invention may, however, be embodied in many different forms and should not be construed as limited to the examples set forth herein; rather, these examples are provided so that this disclosure will be thorough and complete, and will fully convey the scope of the invention to those skilled in the art. The terminology used in the detailed description of the examples illustrated in the accompanying drawings is not intended to be limiting of the invention. In the drawings, like numbers refer to like elements.

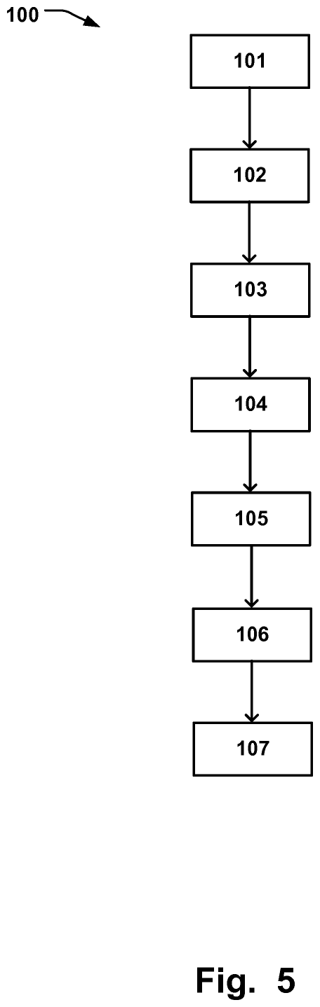

FIG. 5 illustrates a flow chart of a method 100 of fault prediction of a cyclically moving machine component. The order in which the steps of the method 100 are described and illustrated should not be construed as limiting and it is conceivable that the steps can be performed in varying order.

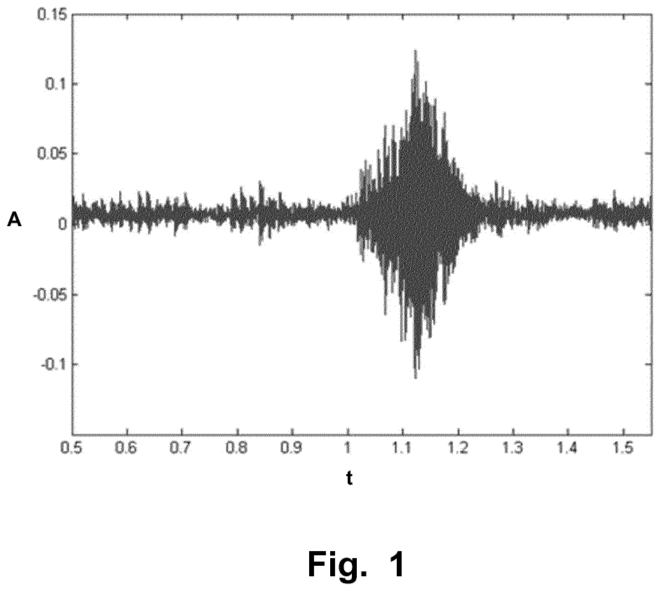

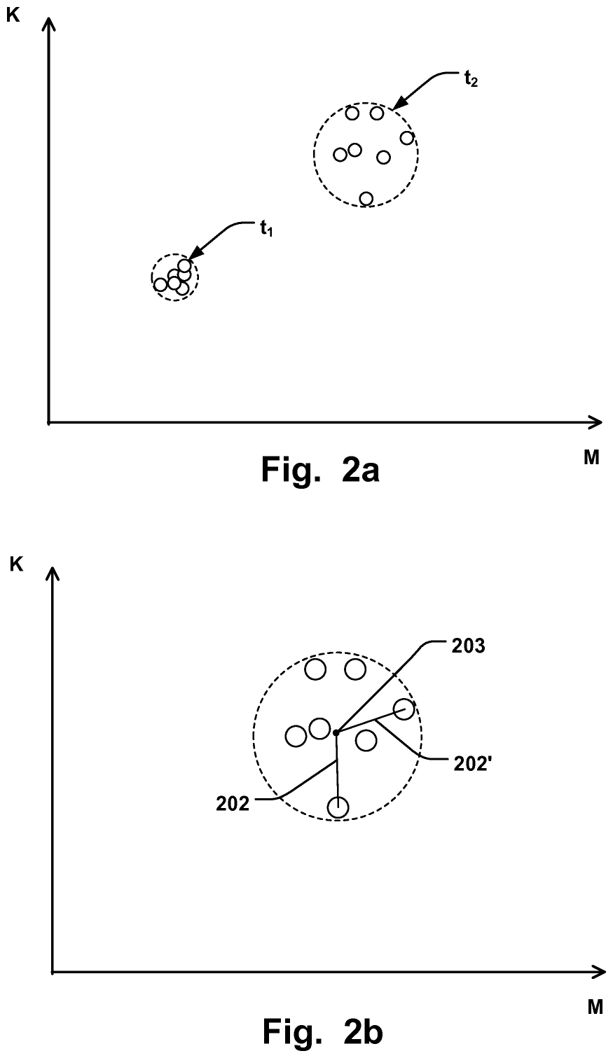

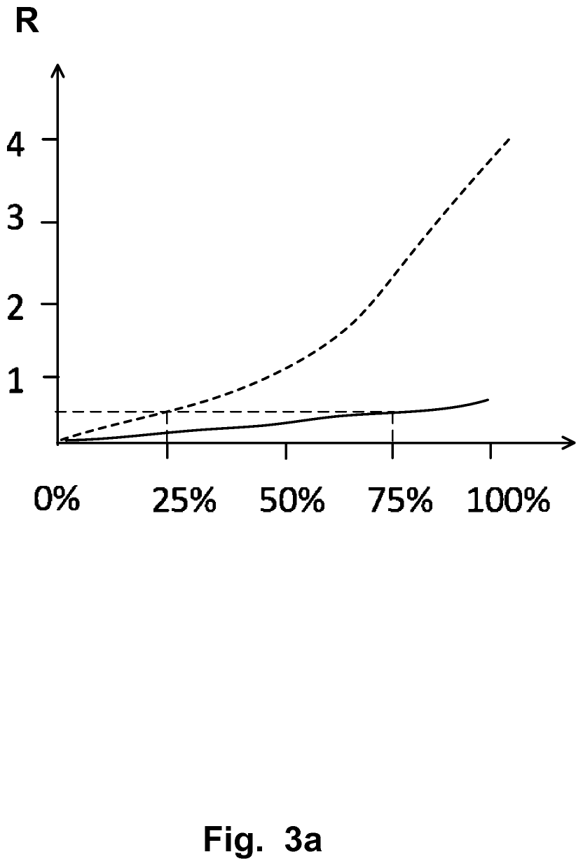

A method 100 of fault prediction of a cyclically moving machine component is thus provided. In this example, each cycle of a plurality of cycles of a motion of the component generates a data distribution of values of measurable movement characteristics during a duration of each cycle. FIG. 1 illustrates an example of values of measurable movement characteristics obtained over one cycle of the machine component. The data distribution in FIG. 1 shows the amplitude of a movement, such as a vibrational movement, as function of time, i.e. over the duration of one cycle. It is conceivable that various other measurable movement characteristics of the cycle can be determined for the purposes of carrying out the method 100, such as values of torque or any other force, speed, or acceleration describing the movement of the machine component during one cycle. For each cycle, the method 100 comprises determining 101 the data distribution of the movement characteristics, i.e. retrieving the data such as illustrated in the example of FIG. 1, e.g. by employing various types of sensors configured to detect the mentioned movement characteristics. The method 100 comprises calculating 102 a measure of central tendency of the values in the data distribution. The measure of central tendency should be construed according to the normal meaning of the term within statistical theory, i.e. as a central or typical value for a probability distribution, e.g. for the data distribution illustrated in the example of FIG. 1. The method 100 further comprises calculating 103 a quantified measure of a shape of the data distribution over the duration of each cycle. Also, the shape of the data distribution should be construed according to the normal meaning of the term within statistical theory, i.e. describing the shape of the curvature of the data distribution in FIG. 1, such as the characteristics of the tails of such data distribution, e.g. how wide or thin the tails of the distribution are, which is influenced by the number of outliers of the data points, i.e. the number of data points being far removed from the main distribution around the center of the data distribution. The method 100 comprises associating 104 the measure of central tendency with said quantified measure of the shape as a coupled set of condition parameters. I.e. for each cycle, a set of condition parameters is determined, where each set is a pair of data points comprising the measure of central tendency and the quantified measure of the shape of the data distribution. FIGS. 2a-b are schematic diagrams where each data point (small circles with solid lines) correspond to a coupled set of condition parameters. The quantified measure of the shape of the data distribution is given on the vertical axis (K), and the measure of central tendency is given on the horizontal axis (M). The method 100 comprises determining 105 a degree of dispersion of a plurality of coupled sets of condition parameters associated with a plurality of cycles of the cyclically moving component. The dispersion is indicative of how far each of the coupled sets of condition parameters are removed from each other. In the example of FIG. 2a, the plurality of coupled sets of condition parameters have been determined for two points in time, t₁ and t₂. At time t₂ the degree of dispersion is larger than at time t₁. The method 100 comprises comparing 106 the degree of dispersion, e.g. at time t₂, with a dispersion threshold value for said fault prediction. An exceeded threshold value can thus be indicative of increased wear of the cyclically moving machine component. Alternatively, a trend of the degree of dispersion over time can be determined 107, for said fault prediction. For example, a trend of increased dispersion, going from t₁ to t₂, can be indicative of increased wear of the cyclically moving machine component.

Thus, by associating 104 the measure of central tendency with the quantified measure of the shape as a coupled set of condition parameters, and determining the degree of dispersion thereof for a plurality of cycles, a facilitated and reliable indication of increased wear, or a generally faulty machine component, can be obtained, without the need for complex frequency analysis of the movement characteristics of the component. The various assumptions made in such traditional frequency analysis are thus not needed, and the method of fault prediction described in the present disclosure can be employed to achieve a reliable condition monitoring in a wide variety of applications. The method 100 provides for a method of fault prediction having short execution time and thereby enabling analysis on-the-fly and generally a less time-consuming trouble-shooting of cyclically moving machine components such as bearings, belts, motors and related components thereof. Such improved fault prediction may be particularly advantageous in filling machines, and related components thereof, in high-speed production lines where condition monitoring is critical for maintaining a high throughput.

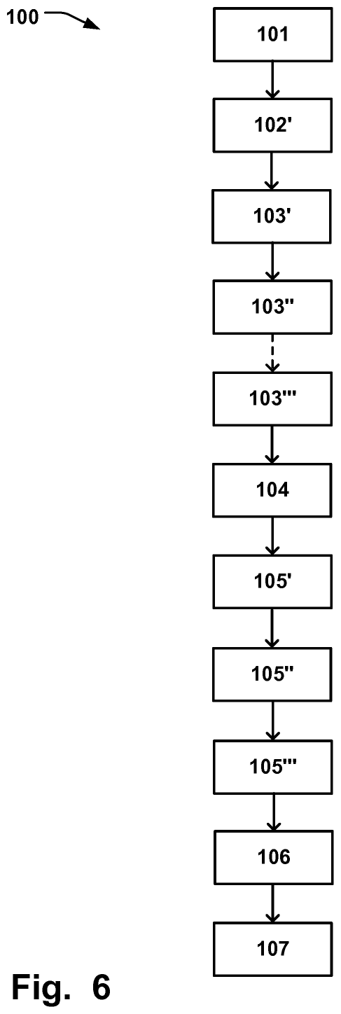

FIG. 6 illustrates a further flow chart of a method 100 of fault prediction of a cyclically moving machine component. The order in which the steps of the method 100 are described and illustrated should not be construed as limiting and it is conceivable that the steps can be performed in varying order.

Calculating 102 the measure of central tendency the values in the data distribution may comprise calculating 102′ a mean value, such as an arithmetic mean, and/or a geometric mean, and/or a harmonic mean, and/or a generalized mean such as a quadratic mean (RMS), and/or other measures of a central tendency of the data distribution such as a median value or a mode value, and/or differently weighted and/or truncated variants thereof. The method 100 may be optimized to various applications depending on the particular measure of central tendency employed. An efficient condition monitoring and fault prediction can thereby be achieved for a range of applications and movement characteristics.

Calculating 103 a quantified measure of the shape of the data distribution may comprise calculating 103′ a measure of a distribution of the measured movement characteristics around the measure of central tendency. Thus, the shape of the data distribution around the measure of central tendency is determined, which subsequently is associated with the latter for providing the set of coupled condition parameters for the particular cycle.

Calculating a measure of the distribution of the measured movement characteristics around the measure of central tendency may comprise calculating 103″ a measure of a deviation from a standard normal distribution. This will provide a measure of how the shape of the data distribution is different from a standard normal distribution, e.g. if the tails of the distribution are thicker—i.e. more concentrated towards the measure of central tendency—or thinner tails—i.e. in a more even “low-profiled” distribution with a greater spread around the measure of central tendency. The shape of the data distribution can thus be considered as a measure that the describes the shape of the distribution's tails in relation to its overall shape.

Calculating a quantified measure of a shape of the data distribution may comprise calculating 103′″ a kurtosis value of the data distribution. Thus, kurtosis is such a measure of the shape of the data distribution. There are typically three categories of kurtosis that can be displayed by a set of data. All measures of kurtosis can be compared against a standard normal distribution, or bell curve. The first category of kurtosis is a mesokurtic distribution. This type of kurtosis is the most similar to a standard normal distribution in that it also resembles a bell curve. However, a graph that is mesokurtic has fatter tails than a standard normal distribution and has a slightly lower peak. This type of kurtosis is considered normally distributed but is not a standard normal distribution. The second category is a leptokurtic distribution. Any distribution that is leptokurtic displays greater kurtosis than a mesokurtic distribution. Characteristics of this type of distribution is one with thicker tails and a substantially thin and tall peak. The other type of distribution is a platykurtic distribution. These types of distributions have slender tails and a peak that's smaller than a mesokurtic distribution. Other measures of the shape of the data distribution may be determined, such as the skewness describing asymmetry from the normal distribution in a set of data. The method 100 may be thus optimized to various applications depending on the particular measure of the shape of the data distribution employed.

The movement characteristics may comprises vibration data of the cyclically moving component, but as mentioned, the movement characteristics may comprises other types or combinations of data such as speed, acceleration, torque etc.

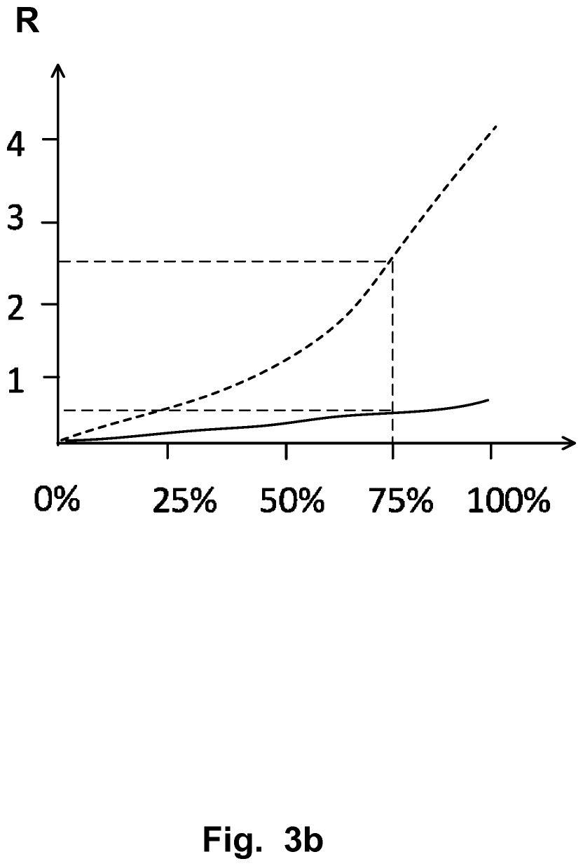

Determining 105 a degree of dispersion of the plurality of coupled sets of condition parameters may comprise determining 105′ a fraction of the plurality of coupled sets of condition parameters being contained within a set threshold dispersion. The threshold dispersion may be illustrated as a circle, having a particular radius (R), in which a predetermined amount of the coupled sets of condition parameters (i.e. the data points in FIGS. 2a-b) should be contained. In the example of FIG. 2a, 100% of the data points are contained within the respective circles at times t₁ and t₂, since the radius has been increased at t₂ to accommodate the increased degree of dispersion. If the radius is kept fixed, however, over time, the fraction of data points contained within the radius will decrease. In the example of FIG. 3a, the radius (R) is illustrated on the vertical axis, and the fraction of data points being contained within the respective radiuses is illustrated on the horizontal axis, for two different components (solid and dashed line, respectively). For example, 75% of the data points of a healthy component (the solid line) are contained within a radius of approximately 0.5, while only 25% of the data points of a faulty component (the dashed lines) are contained within this radius (R). This is thus indicative of an increased dispersion of the plurality of coupled sets of condition parameters for the faulty component. It is also conceivable that a single component is illustrated in FIG. 3a, but at the two different points in time (t₁, t₂). Thus, as time progress from t₁ to t₂, the healthy component becomes faulty with a significant reduction in the fraction of data points (coupled sets of condition parameters) being contained within the radius at 0.5. An acceptable range in the fraction of the data points to be contained within the defined radius may thus be set. Alternatively, a fixed fraction of data points to be contained may be defined, such as illustrated in FIG. 3b, where the respective radiuses fall within a range. In this example, 75% of the data points fall within a range of the radius (R) of between 0.5 and 2.5. An acceptable range in the radius may thus be defined.

Determining a degree of dispersion of the plurality of coupled sets of condition parameters may comprise determining 105″ the distances 202, 202′, between a center 203 of a distribution of the plurality of coupled sets of condition parameters and each coupled set of condition parameters. FIG. 2b schematically illustrates how the distances 202, 202′, to two different data points, i.e. coupled sets of condition parameters, have been determined with respect to a determined center 203 of the distribution. The distance may thus be an Euclidian distance between the aforementioned points. It is conceivable however that other measures of the dispersion of the data points may be utilized.

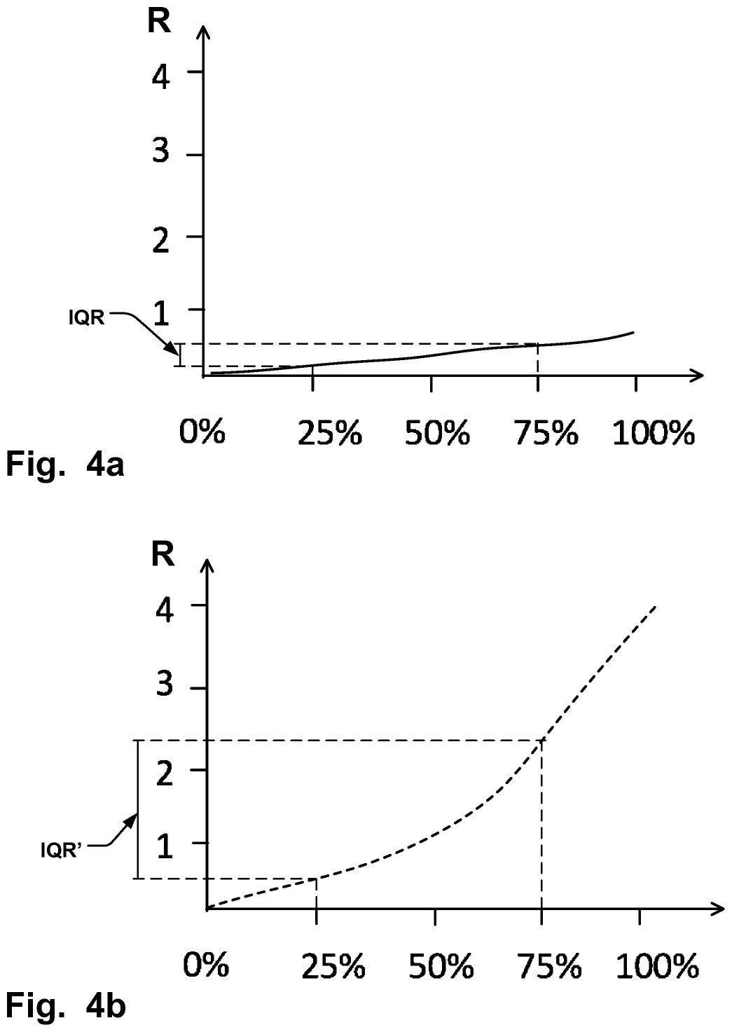

The degree of dispersion may be determined by calculating 105′″ the spread of the interquartile range (IQR, IQR′) of the coupled sets of condition parameters. FIGS. 4a-b illustrate an increase in the interquartile range, i.e. a spread in the range of radiuses in which 25-75% of the data points are contained. Thus, as the dispersion increased in FIG. 4b, the interquartile range IQR′ is increased, providing for an efficient measure of the dispersion of the coupled sets of condition parameters.

A computer program product is provided comprising instructions which, when the program is executed by a computer, cause the computer to carry out the steps of the method 100 as described above in relation to FIGS. 1-6.

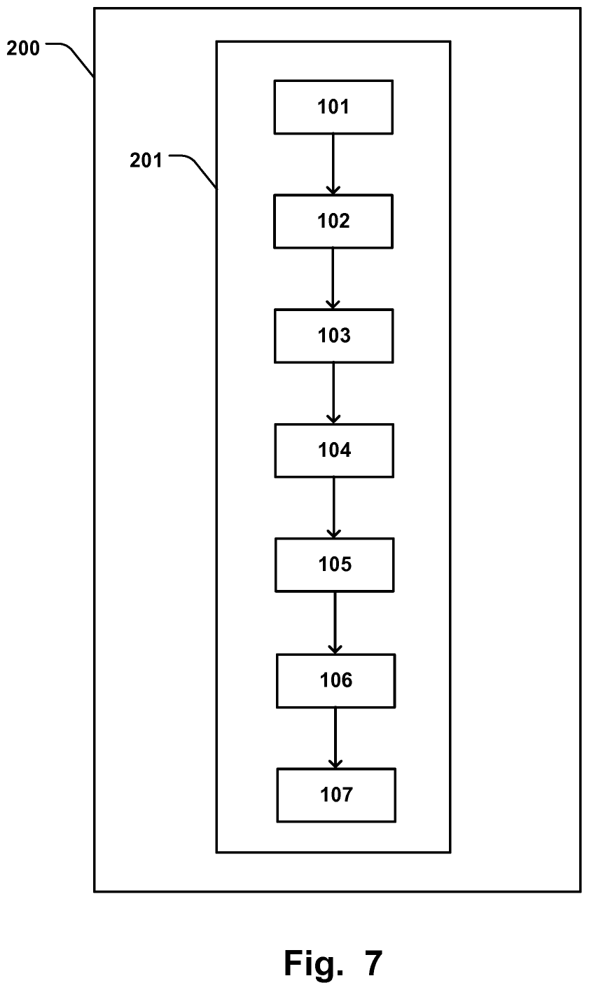

An apparatus 200 configured to predict fault in a cyclically moving component is also provided. As mentioned, each cycle of a plurality of cycles of a motion of the component generates a data distribution of values of measurable movement characteristics during a duration of each cycle. The apparatus comprises a processing unit 201, being schematically illustrated in FIG. 7, which is configured to, for each cycle; determine 101 said data distribution of the movement characteristics; calculate 102 a measure of central tendency of the values in the data distribution; calculate 103 a quantified measure of a shape of the data distribution over the duration of each cycle; associate 104 the measure of central tendency with said quantified measure as a coupled set of condition parameters; determine 105 a degree of dispersion of a plurality of coupled sets of condition parameters associated with a plurality of cycles of the cyclically moving component; and compare 106 the degree of dispersion with a dispersion threshold value, or determine 107 a trend of the degree of dispersion over time, for said fault prediction. The apparatus 200 thus provides for the advantageous benefits as described above in relation to the method 100 with reference to FIGS. 1-6. I.e. the apparatus 200 provides for a facilitated and reliable condition monitoring and fault prediction with indication of increased wear, or generally faulty machine components, without the need for complex frequency analysis of the movement characteristics of the components.

The processing unit 201 may be configured to calculate the measure of central tendency of the values in the data distribution by calculating 102′ a mean value, such as an arithmetic mean, and/or a geometric mean, and/or a harmonic mean, and/or a generalized mean, and/or other measures of a central tendency of the data distribution such as a median value or a mode value.

The processing unit 201 may be configured to calculate a quantified measure of a shape of said data distribution by calculating 103′″ a kurtosis value of said data distribution.

The processing unit 201 may be configured to determine the degree of dispersion of the plurality of coupled sets of condition parameters by calculating 105′ a fraction of the plurality of coupled sets of condition parameters being contained within a set threshold dispersion.

The processing unit 201 may be configured to determine a degree of dispersion of the plurality of coupled sets of condition parameters by calculating 105″ the distances 202, 202′ between a center 203 of a distribution of the plurality of coupled sets of condition parameters and each coupled set of condition parameters.

The present invention has been described above with reference to specific examples. However, other examples than the above described are equally possible within the scope of the invention. The different features and steps of the invention may be combined in other combinations than those described. The scope of the invention is only limited by the appended patent claims.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

1. A method of fault prediction of a cyclically moving machine component, wherein each cycle of a plurality of cycles of a motion of the component generates a data distribution of values of measurable movement characteristics during a duration of each cycle, the method comprising, for each cycle:
determining said data distribution of the measurable movement characteristics,
calculating a measure of central tendency of the values in the data distribution,
calculating a quantified measure of a shape of the data distribution over the duration of each cycle,
associating the measure of central tendency with said quantified measure of the shape as a coupled set of condition parameters,
determining a degree of dispersion of a plurality of coupled sets of condition parameters associated with the plurality of cycles of the motion of the cyclically moving machine component, and
comparing the degree of dispersion with a dispersion threshold value, or determining a trend of the degree of dispersion over time, for said fault prediction.

2. The method according to claim 1, wherein calculating the measure of central tendency of the values in the data distribution comprises:
calculating at least one of an arithmetic mean, a geometric mean, a harmonic mean, or a generalized mean and/or other measures of a central tendency of the data distribution including a median value or a mode value.

3. The method according to claim 1, wherein calculating the quantified measure of a shape of said data distribution comprises:
calculating a measure of a distribution of the measurable movement characteristics around said measure of central tendency.

4. The method according to claim 3, wherein calculating the measure of a distribution of the measurable movement characteristics around said measure of central tendency comprises:
calculating a measure of a deviation from a standard normal distribution.

5. The method according to claim 1, wherein calculating the quantified measure of the shape of said data distribution comprises:
calculating a kurtosis value of said data distribution.

6. The method according to claim 1, wherein the measurable movement characteristics comprises vibration data of the cyclically moving machine component.

7. The method according to claim 1, wherein determining the degree of dispersion of the plurality of coupled sets of condition parameters comprises:
determining a fraction of the plurality of coupled sets of condition parameters being contained within a set threshold dispersion.

8. The method according to claim 1, wherein determining the degree of dispersion of the plurality of coupled sets of condition parameters comprises:
determining distances between a center of a distribution of the plurality of coupled sets of condition parameters and each coupled set of condition parameters.

9. The method according to claim 1, wherein
determining the degree of dispersion of the plurality of coupled sets of condition parameters comprises:
calculating a spread of an interquartile range of the coupled sets of condition parameters.

10. A computer program product comprising instructions which, when executed by a computer, cause the computer to carry out the method according to claim 1.

11. An apparatus configured to predict fault in a cyclically moving machine component, wherein each cycle of a plurality of cycles of a motion of the component generates a data distribution of values of measurable movement characteristics during a duration of each cycle, the apparatus comprising a processor configured to, for each cycle:
determine said data distribution of the measurable movement characteristics,
calculate a measure of central tendency of the values in the data distribution,
calculate a quantified measure of a shape of the data distribution over the duration of each cycle,
associate the measure of the central tendency with said quantified measure as a coupled set of condition parameters,
determine a degree of dispersion of a plurality of coupled sets of condition parameters associated with the plurality of cycles of the motion of the cyclically moving machine component, and
compare the degree of dispersion with a dispersion threshold value, or determine a trend of the degree of dispersion over time, for said fault prediction.

12. The apparatus according to claim 11, wherein said processor is configured to calculate the measure of central tendency of the values in the data distribution by calculating at least one of an arithmetic mean, a geometric mean, a harmonic mean, or a generalized mean and/or other measures of a central tendency of the data distribution including a median value or a mode value.

13. The apparatus according to claim 11, wherein said processor is configured to calculate the quantified measure of the shape of said data distribution by calculating a kurtosis value of said data distribution.

14. The apparatus according to claim 11, wherein said processor is configured to determine the degree of dispersion of the plurality of coupled sets of condition parameters by calculating a fraction of the plurality of coupled sets of condition parameters being contained within a set threshold dispersion.

15. The apparatus according to claim 11, wherein said processor is configured to determine the degree of dispersion of the plurality of coupled sets of condition parameters by calculating distances between a center of a distribution of the plurality of coupled sets of condition parameters and each coupled set of condition parameters.

16. The apparatus according to claim 11, wherein said processor is configured to calculate said quantified measure of a shape of said data distribution by calculating a measure of a distribution of the measurable movement characteristics around the measure of central tendency.

17. The apparatus according to claim 16, wherein said processor is configured to calculate the measure of a distribution of the measurable movement characteristics around the measure of central tendency by calculating a measure of a deviation from a standard normal distribution.

18. The apparatus according to claim 11, wherein the measurable movement characteristics comprise vibration data of the cyclically moving machine component.

19. The apparatus according to claim 11, wherein said processor is configured to determine the degree of dispersion of the plurality of coupled sets of condition parameters by calculating a spread of an interquartile range of the coupled sets of condition parameters.
